(19) United States
(12) Patent Application Publication
(10) Pub. No.: US 2011/0176033 A1
(43) Pub. Date: Jul. 21, 2011

(54) CAMERA AND METHOD FOR CAPTURING AND PROCESSING PHOTOS IN CAMERA

(75) Inventor: JUN LIU, Shenzhen City (CN)

(73) Assignees: HONG FU JIN PRECISION INDUSTRY (ShenZhen) CO., LTD, Shenzhen City (TW); HON HAI PRECISION INDUSTRY CO., LTD., Tu-Cheng (TW)

(21) Appl. No.: 12/750,931

(22) Filed: Mar. 31, 2010

(30) Foreign Application Priority Data
Jan. 20, 2010 (CN) 201010300448.7

(51) Int. Cl. H04N 5/262

(52) U.S. Cl. 348/239; 348/E05.051

(57) ABSTRACT

A camera includes a light detecting module, an exposure value analyzing module, a capture module and a photo compositing module. The light detecting module is capable of calculating a plurality of exposure values by measuring brightness of light in a plurality of detecting areas defined in a capture view. The exposure value analyzing module is capable of selecting a maximum exposure value and a minimum exposure value from the plurality of exposure values. The capture module is capable of capturing an over exposure value photo from the capture view according to the maximum exposure value, and capturing an under exposure value photo from the capture view according to the minimum exposure value. The photo compositing module is capable of merging the over exposure value photo and the under exposure value photo to a final photo. A method for capturing and processing photos in the camera is also disclosed.

### BACKGROUND

1. Technical Field

The present disclosure relates to cameras and methods for capturing and processing photos in cameras, especially to a camera and a method to capture a photo in backlighting condition.

2. Description of Related Art

In photography, lighting instruments, such as the sun may cause some areas of the photo is glow, while the other areas can be dark. The exposure value of the photo can be manually adjusted by the user changing the setting before the photo is captured. However, one photo has only one still exposure value when capturing, some portions of the photo may still glow or be dark due to the high brightness of the lighting instruments.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a camera in accordance with an embodiment.

FIG. 2 is a schematic view of a capture view including a plurality of detecting areas.

FIG. 3 is schematic view of an over-exposed photo, a under exposed photo and a final photo.

FIG. 4 is a flow chart of an embodiment of a method for capturing and processing photos in the camera.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

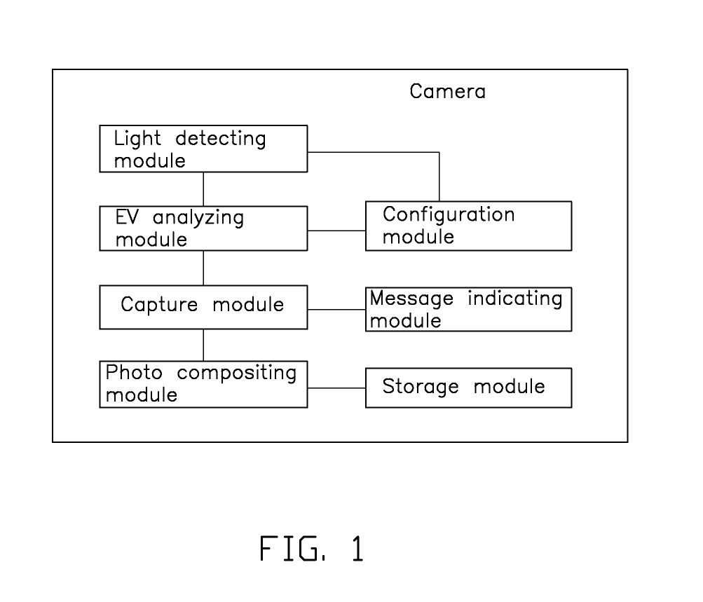

FIG. 1 illustrates a camera, in accordance with an embodiment, that includes a light detecting module, an exposure value (EV) analyzing module, a capture module, a photo compositing module, a configuration module, a message indicating module and a storage module. In photography, EV denotes all combinations of camera exposure time and a relative aperture that gives the same exposure. The exposure time determines the amount of motion blur, and the relative aperture determines the depth of field. The light detecting module, the EV analyzing module, the capture module and the photo compositing module are connected in sequence. The configuration module is connected to the light detecting module and the EV analyzing module. The message indicating module is connected to the capture module. The storage module is connected to the photo compositing module.

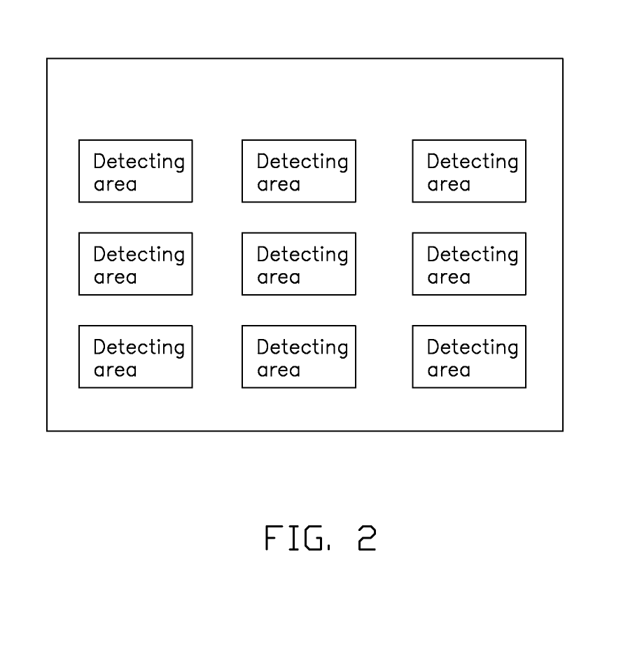

FIG. 2 illustrates a capture view of the camera. A plurality of detecting areas is defined in the capture view. The number of detecting areas is determined according to the embodiment. In one embodiment, there are nine detecting areas, and the nine detecting areas aligned in three columns and three rows. The light detecting module can calculate an EV by measuring brightness of light in each detecting area, so that a plurality of EVs can be received. The brightness of light in each detecting area is measured by through-the-lens (TTL) metering.

The EV analyzing module can select a maximum EV and a minimum EV from the received EVs. The EV analyzing module can detect a range value from the maximum EV to the minimum EV, if the range value exceeds a predefined standard value, both the over-exposed photo and the under-exposed photo can be captured. The configuration module can adjust the user set predefined standard value.

The capture module can capture an over-exposed photo from the capture view according to the maximum EV, and capture a under-exposed photo from the capture view according to the minimum EV. The over-exposed photo and the under-exposed photo are obtained by pressing the shutter continually or, for example, the shutter is pressed twice in 3 seconds. A message is displayed in the camera after the over-exposed photo and the under-exposed photo are captured, so that user can remove the camera from the capture view.

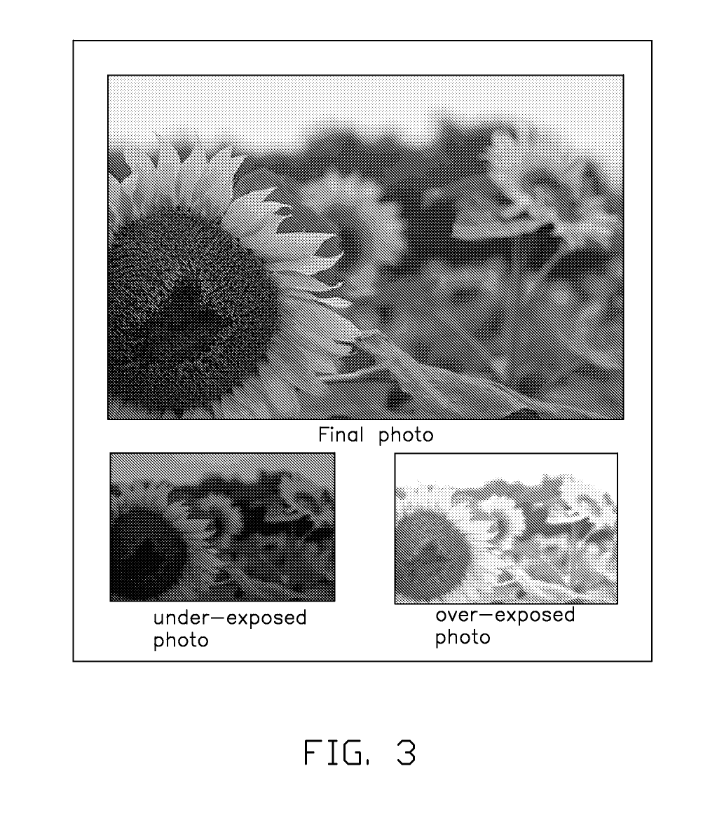

The compositing module can merge the over-exposed photo and the under-exposed photo to the final photo. FIG. 3 illustrates an example of the over-exposed photo, the under-exposed photo and a final photo.

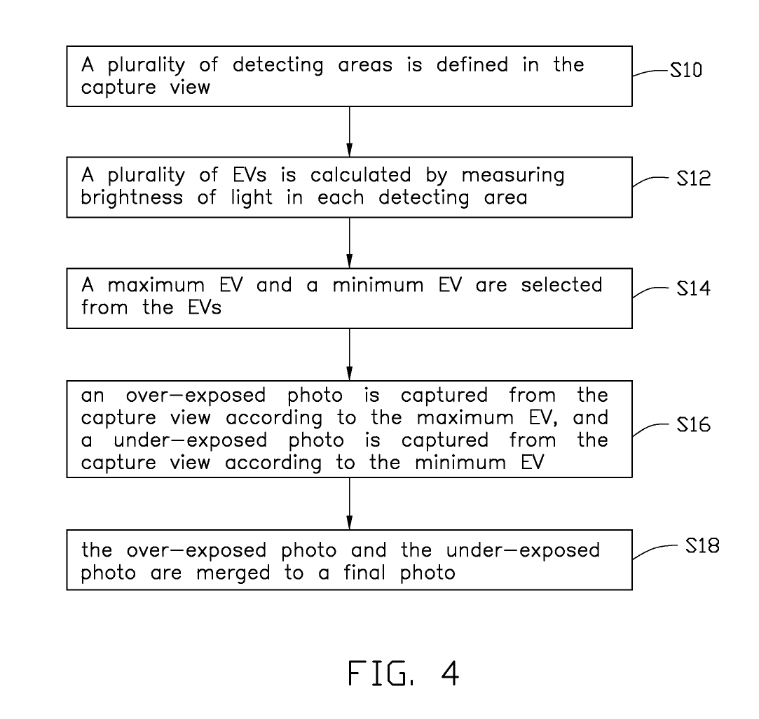

FIG. 4 illustrates a flow chart of a method for capturing and processing photos in the camera, in accordance with one embodiment.

In block S10, a plurality of detecting areas is defined in the capture view.

In block S12, a plurality of EVs is calculated by measuring brightness of light in each detecting area.

In block S14, a maximum EV and a minimum EV are selected from the plurality of EVs.

In block S16, an over-exposed photo is captured from the capture view according to the maximum EV, and a under-exposed photo is captured from the capture view according to the minimum EV.

In block S18, the over-exposed photo and the under-exposed photo are merged to a final photo.

According to the embodiment, a range value from the maximum EV to the minimum EV is detected before the over-exposed photo and the under-exposed photo are captured. The EV analyzing module can detect if the range value exceeds a predefined standard value. The EV analyzing module will capture the over-exposed photo and the under-exposed photo if the range value is larger than the predefined standard value, and will capture only one normal photo according to an average value of the maximum EV and the minimum EV. The final photo is stored in the storage module.

Depending on the embodiment, certain steps of the methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is also to be understood, however, that even though numerous characteristics and advantages have been set forth in the foregoing description of preferred embodiments, together with details of the structures and functions of the preferred embodiments. The disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for capturing and processing photos in a camera comprising:
defining a plurality of detecting areas in a capture view;
calculating a plurality of exposure values (EVs) by measuring brightness of light in each detecting area;
selecting a maximum EV and a minimum EV from the plurality of EVs;
capturing an over-exposed photo from the capture view according to the maximum EV, and capturing a under-exposed photo from the capture view according to the minimum EV; and
merging the over-exposed photo and the under-exposed photo to a final photo.

2. The method of claim 1, wherein the over-exposed photo and the under-exposed photo are obtained by pressing a shutter continually.

3. The method of claim 1, wherein the plurality of detecting areas comprises of nine detecting areas in the capture view, and the nine detecting areas are aligned in three lines and three rows.

4. The method of claim 1 further comprising detecting a range value from the maximum EV to the minimum EV, if the range value exceeds a predefined standard value, the over-exposed photo and the under-exposed photo are captured.

5. The method of claim 1 further comprising displaying a message in the camera after the over-exposed photo and the under-exposed photo are captured.

6. The method of claim 1, wherein brightness of light in each detecting area is measured by through-the-lens metering.

7. The method of claim 1, wherein storing the final photo to a storage module.

8. A camera comprising:
a light detecting module, the light detecting module is capable of calculating a plurality of exposure values (EVs) by measuring brightness of light in a plurality of detecting areas in a capture view;
an EV analyzing module, the EV analyzing module is capable of selecting a maximum EV and a minimum EV from the plurality of EVs;
a capture module, the capture module is capable of capturing an over-exposed photo from the capture view according to the maximum EV, and capturing an under-exposed photo from the capture view according to the minimum EV; and
a photo compositing module, the photo compositing module is capable of merging the over-exposed photo and the under-exposed photo to a final photo.

9. The camera of claim 8, wherein the over-exposed photo and the under-exposed photo are obtained by pressing a shutter continually.

10. The camera of claim 9, wherein the detecting areas comprises of nine detecting areas in the capture view, and the nine detecting areas are aligned in three lines and three rows.

11. The method of claim 9, wherein the EV analyzing module is capable of detecting a range value from the maximum EV to the minimum EV, if the range value exceeds a predefined standard value, the over-exposed photo and the under-exposed photo are captured.

12. The camera of claim 9 further comprising a configuration module, wherein the configuration module is capable of adjusting the predefined standard value.

13. The camera of claim 9 further comprising a message indicating module, wherein the message indicating module is capable of displaying a message in the camera after the over-exposed photo and the under-exposed photo are captured.

14. The camera of claim 9, wherein brightness of light in each detecting area is measured by through-the-lens metering.

15. The camera of claim 9 further comprising a storage module, wherein the storage module is capable of storing the final photo.
